(19) United States
(12) Patent Application Publication
(10) Pub. No.: US 2018/0349743 A1
(43) Pub. Date: Dec. 6, 2018

(54) CHARACTER RECOGNITION USING ARTIFICIAL INTELLIGENCE

(71) Applicant: ABBYY Development LLC, Moscow (RU)

(72) Inventor: Chulinin Iurii, Moscow (RU)

(21) Appl. No.: 15/630,638

(22) Filed: Jun. 22, 2017

(30) Foreign Application Priority Data
May 30, 2017 (RU) 2017118756

(51) Int. Cl. G06K 9/62; G06N 99/00

(52) U.S. Cl. CPC G06K 9/6267; G06N 99/005; G06K 2209/013; G06K 2209/011; G06K 9/6256

(57) ABSTRACT

A method may include identifying, by a processing device, an image of a hieroglyph, providing the image of the hieroglyph as input to a trained machine learning model to determine a combination of components at a number of positions in the hieroglyph, and classifying the hieroglyph as a particular language character based on the determined combination of components at the number of positions in the hieroglyph. Another method may include training the machine learning model to determine the combination of components at the number of positions.

### TECHNICAL FIELD

The present disclosure is generally related to computer systems, and is more specifically related to systems and methods for recognizing characters using artificial intelligence.

### BACKGROUND

Optical character recognition (OCR) techniques may vary depending on which language is under consideration. For example, recognizing characters in text written in Asian languages (e.g., Chinese, Japanese, Korean (CJK)) poses different challenges than text written in European languages. A basic image unit in CJK languages is a hieroglyph (e.g., a stylized image of a character, phrase, word, letter, syllable, sound, etc.). Together, CJK languages may include more than fifty thousand graphically unique hieroglyphs. Thus, using certain artificial intelligence techniques to recognize the fifty thousand hieroglyphs in a CJK language may entail hundreds of millions of examples of hieroglyph images. Assembling an array of high-quality images of hieroglyphs may be an inefficient and difficult task.

### SUMMARY OF THE DISCLOSURE

In one implementation, a method includes identifying, by a processing device, an image of a hieroglyph, providing the image of the hieroglyph as input to a trained machine learning model to determine a combination of components at a plurality of positions in the hieroglyph, and classifying the hieroglyph as a particular language character based on the determined combination of components at the plurality of positions in the hieroglyph.

In another implementation, a method for training one or more machine learning models to identify a presence or absence of graphical elements in a hieroglyph includes generating training data for the one or more machine learning models. The training data includes a first training input including pixel data of an image of a hieroglyph, and a first target output for the first training input. The first target output identifies a plurality of positions in the hieroglyph and a likelihood of a presence of a graphical element in each of the plurality of positions in the hieroglyph. The method also includes providing the training data to train the one or more machine learning models on (i) a set of training inputs including the first training input and (ii) a set of target outputs including the first target output.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a high-level component diagram of an illustrative system architecture, in accordance with one or more aspects of the present disclosure.

FIG. 2A depicts an example of a graphical element, in accordance with one or more aspects of the present disclosure.

FIG. 2B depicts an example of a hieroglyph including the graphical element of FIG. 2A, in accordance with one or more aspects of the present disclosure.

FIG. 3A depicts an example of three graphical elements representing letters, in accordance with one or more aspects of the present disclosure.

FIG. 3B depicts an example of predetermined positions in a hieroglyph where graphical elements may be located, in accordance with one or more aspects of the present disclosure.

FIG. 3C depicts an example hieroglyph including the graphical elements of FIG. 3A arranged in certain positions of a first configuration, in accordance with one or more aspects of the present disclosure.

FIG. 3D depicts an example hieroglyph including graphical elements arranged in certain positions of a second configuration, in accordance with one or more aspects of the present disclosure.

FIG. 4 depicts a flow diagram of an example method for training one or more machine learning models, in accordance with one or more aspects of the present disclosure.

FIG. 5 depicts a flow diagram of an example method for training one or more machine learning models using backpropagation, in accordance with one or more aspects of the present disclosure.

FIG. 6 depicts a flow diagram of an example method for preprocessing a document to identify images of hieroglyphs, in accordance with one or more aspects of the present disclosure.

FIG. 7 depicts a flow diagram of an example method for classifying a hieroglyph as a particular language character based on a determined combination of components at positions in a hieroglyph, in accordance with one or more aspects of the present disclosure.

FIG. 8 depicts a block diagram of an example of a neural network trained to recognize the presence of components at positions in a hieroglyph, in accordance with one or more aspects of the present disclosure.

FIG. 9 depicts an example array of probability vector components and associated indices output by a machine learning model, in accordance with one or more aspects of the present disclosure.

FIG. 10 depicts an example Unicode table for the Korean language, in accordance with one or more aspects of the present disclosure.

FIG. 11 depicts an example computer system 600 which can perform any one or more of the methods described herein, in accordance with one or more aspects of the present disclosure.

### DETAILED DESCRIPTION

As noted above, in some instances, combining OCR techniques with artificial intelligence techniques, such as machine learning, for example, may entail obtaining a large training sample of hieroglyphs when applied to the CJK languages. Further, collecting the sample of hieroglyphs may be resource intensive. For example, to train a machine learning model to recognize an entire character may entail one hundred different images of the hieroglyph representing the character. Additionally, there are rare characters in the CJK languages for which the number of real-world examples is limited, and collecting one hundred examples for training a machine learning model to recognize the entire rare character is difficult.

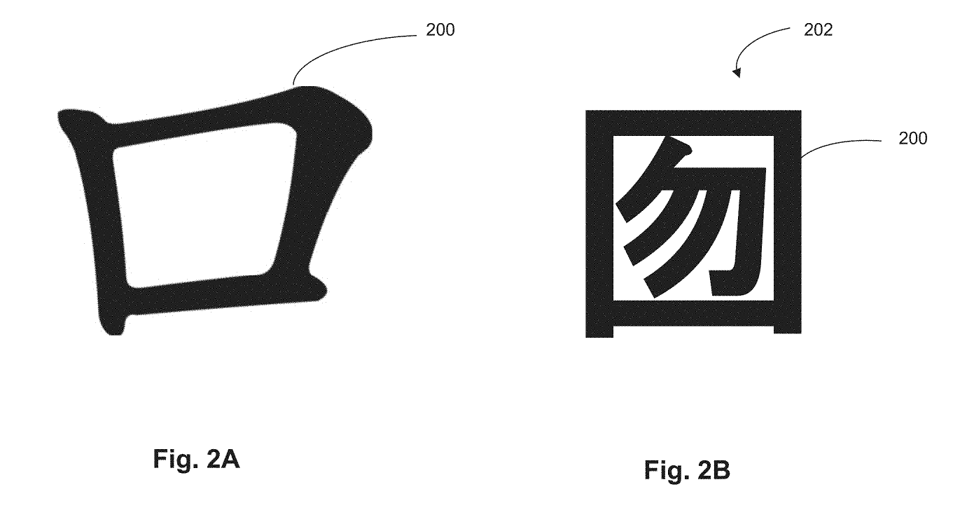

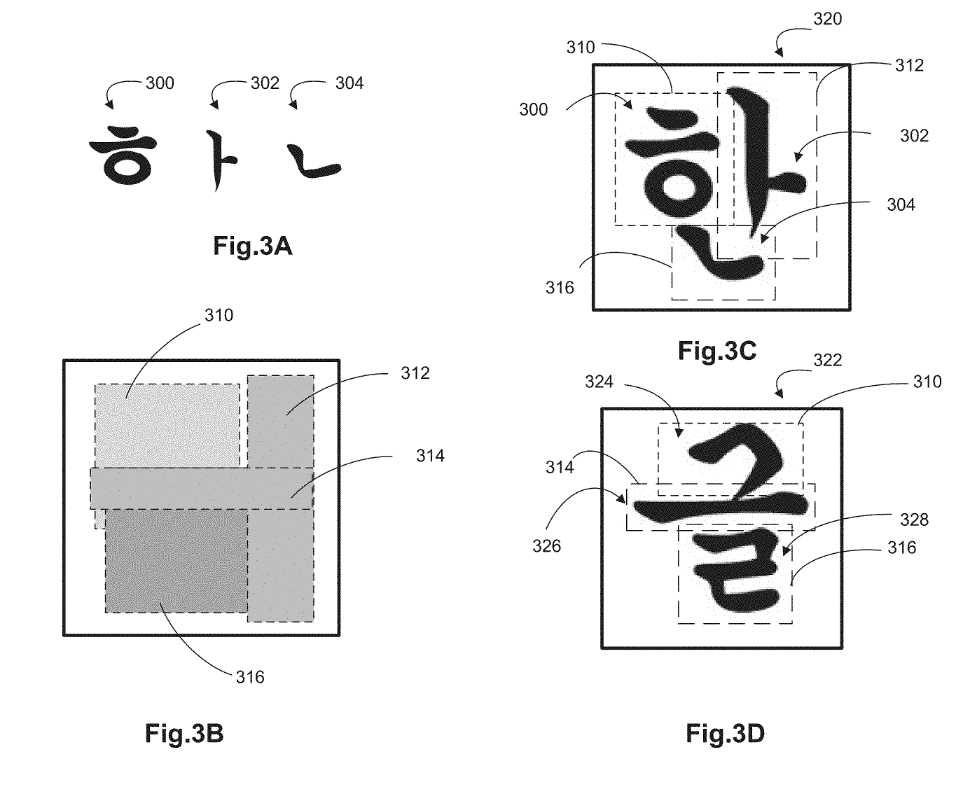

Hieroglyphs (examples shown in FIGS. 2A-2B) in the CJK languages may be broken up into their graphical elements. The term “graphical elements” and “components” may be used interchangeably herein. In the Chinese and Japanese languages, graphical elements are radicals and graphic symbols of phonetic elements. The Korean language is syllabic, so each hieroglyph represents a syllabic block of three graphical elements. Each graphical element is a letter, such as a consonant, vowel, or diphthong. Korean graphical elements have a certain order in a syllable: 1) beginning consonant, 2) middle vowel or diphthong, and 3) final consonant. Further, each of the graphical elements in a hieroglyph has a certain position (e.g., the location within the hieroglyph relative to the center and the rest of the graphical elements). For example, the beginning consonant is located in the first position, the middle vowel is in the second position, and the final consonant is located in the third position (examples shown in FIGS. 3A-3D).

The number of existing graphical elements may be considerably less than the total number of existing hieroglyphs in the CJK languages. To illustrate, the number of Korean beginning consonants is 19, the number of middle vowels or diphthongs is 21, and the number of final consonants, considering possible coupling or their absence in the hieroglyphs, is 28. Thus, there are just 11,172 (19×21×28) unique hieroglyphs. Also, the number of positions that the graphical elements can take in hieroglyphs is limited. That is, depending on the type of graphical element (vowel or consonant), the graphical element may be acceptable in certain positions.

Accordingly, the present disclosure relates to methods and systems for hieroglyph recognition using OCR with artificial intelligence techniques, such as machine learning (e.g., neural networks), that classify the components (e.g., presence or absence of graphical elements) in certain positions of the hieroglyph to recognize the hieroglyphs. In an implementation, one or more machine learning models are trained to determine a combination of components at a plurality of positions in hieroglyphs. The one or more machine learning models are not trained to recognize the entire hieroglyph. During training of the one or more machine learning models, pixel data of an image of a hieroglyph is provided to the machine learning model as input, and positions in the hieroglyph and a likelihood of a presence of a graphical element in each of the plurality of positions in the hieroglyph are provided to the machine learning model as one or more target outputs. For example, the image of the hieroglyph may be tagged with a Unicode code that identifies the hieroglyph, and the Unicode code character table may be used to determine which graphical elements (including absent graphical elements) are located in the positions of the hieroglyph. In this way, the one or more machine learning models may be trained to identify the graphical elements in the positions of the hieroglyph.

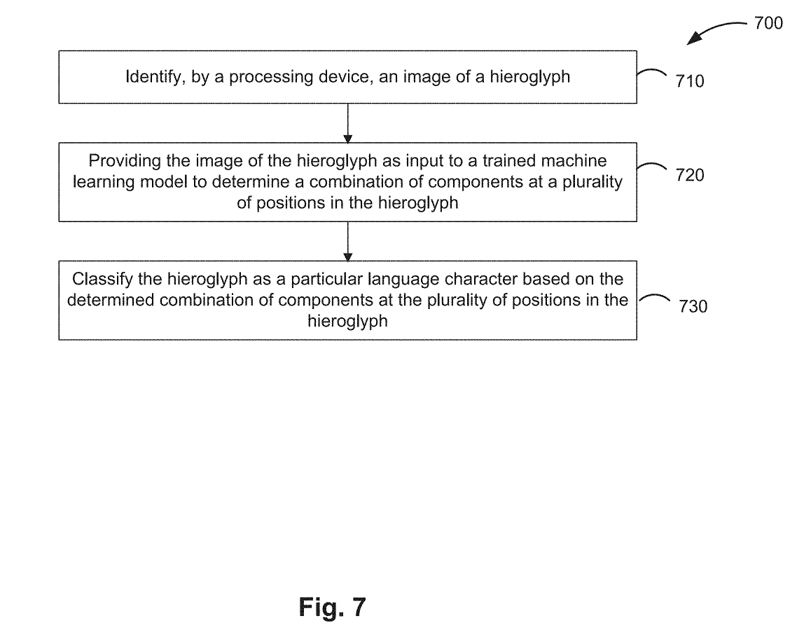

After the one or more machine learning models are trained, a new image of a hieroglyph may be identified for processing that is untagged and has not been processed by the one or more machine learning models. The one or more machine learning models may classify the hieroglyph in the new image as a particular language character based on the determined combination of components at the positions in the hieroglyph. In another implementation, when more than one component is identified for one of the positions or for several of the positions that results in an acceptable combination for more than one hieroglyph, additional classification may be performed to identify the most probable combination of components and their positions in a hieroglyph, as described in more detail below with reference to the method of FIG. 7.

The benefits of using the techniques disclosed herein may include resulting simplified structures for the one or more machine learning models due to classifying graphical elements and not entire hieroglyphs. Further, a reduced training set for recognizing the graphical elements may be used to train the one or more machine learning models, as opposed to a larger training set used to recognize the entire hieroglyph in an image. As a result, the amount of processing and computing resources that are needed to recognize the hieroglyphs is reduced. It should be noted that, although the Korean language is used as an example in the following discussion, the implementations of the present disclosure may be equally applicable to the Chinese and/or Japanese languages.

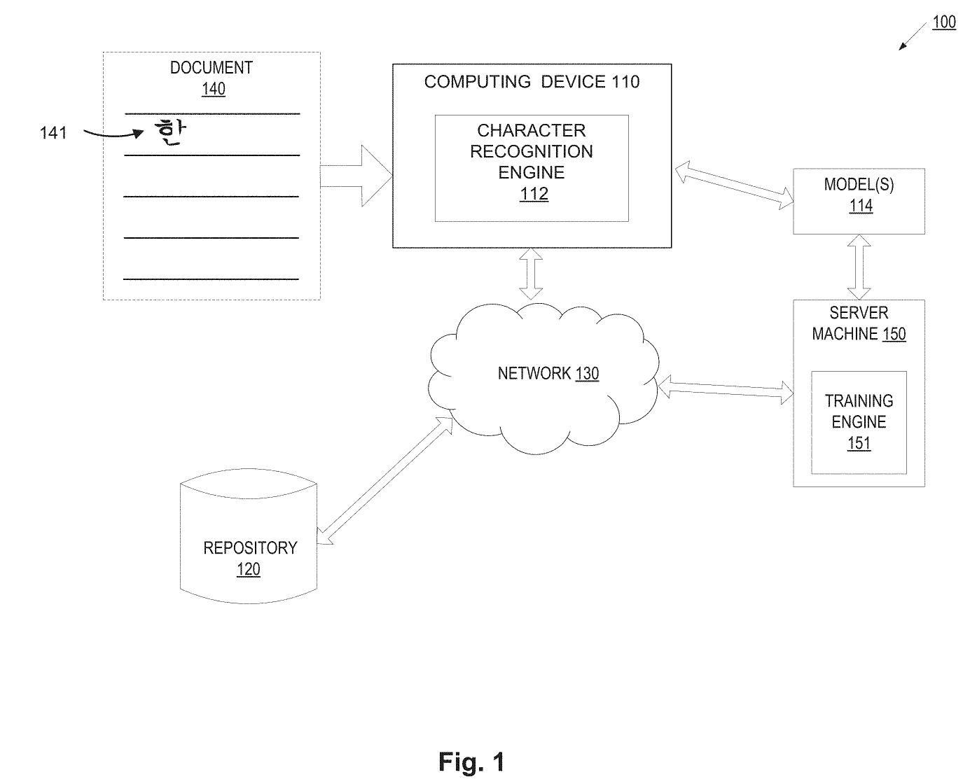

FIG. 1 depicts a high-level component diagram of an illustrative system architecture 100, in accordance with one or more aspects of the present disclosure. System architecture 100 includes a computing device 110, a repository 120, and a server machine 150 connected to a network 130. Network 130 may be a public network (e.g., the Internet), a private network (e.g., a local area network (LAN) or wide area network (WAN)), or a combination thereof.

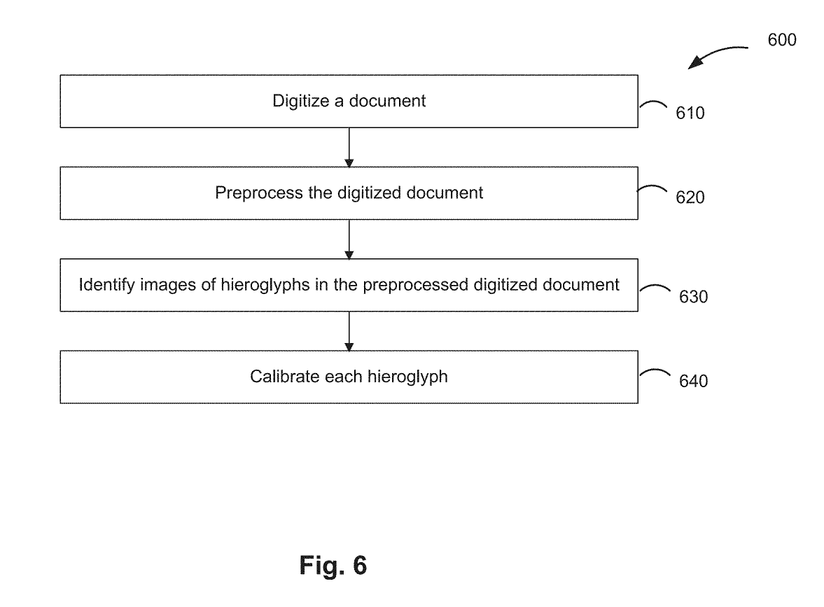

The computing device 110 may perform character recognition using artificial intelligence to classify hieroglyphs based on components identified in positions of the hieroglyphs. The computing device 100 may be a desktop computer, a laptop computer, a smartphone, a tablet computer, a server, a scanner, or any suitable computing device capable of performing the techniques described herein. A document 140 including text written in a CJK language may be received by the computing device 110. The document 140 may be received in any suitable manner. For example, the computing device 110 may receive a digital copy of the document 140 by scanning the document 140 or photographing the document 140. Additionally, in instances where the computing device 110 is a server, a client device connected to the server via the network 130 may upload a digital copy of the document 140 to the server. In instances where the computing device 110 is a client device connected to a server via the network 130, the client device may download the document 140 from the server. Although just one image of a hieroglyph 141 is depicted in the document 140, the document 140 may include numerous images of hieroglyphs 141, and the techniques described herein may be performed for each of the images of hieroglyphs identified in the document 140 being analyzed. Once received, the document 140 may be preprocessed (described with reference to the method of FIG. 6) prior to any character recognition being performed by the computing device 110.

The computing device 100 may include a character recognition engine 112. The character recognition engine 112 may include instructions stored on one or more tangible, machine-readable media of the computing device 110 and executable by one or more processing devices of the computing device 110. In an implementation, the character recognition engine 112 may use one or more machine learning models 114 that are trained and used to determine a combination of components at positions in the hieroglyph of the image 141. In some instances, the one or more machine learning models 114 may be part of the character recognition engine 112 or may be accessed on another machine (e.g., server machine 150) by the character recognition 112. Based on the output of the machine learning model 114, the character recognition engine 112 may classify the hieroglyph in the image 141 as a particular language character.

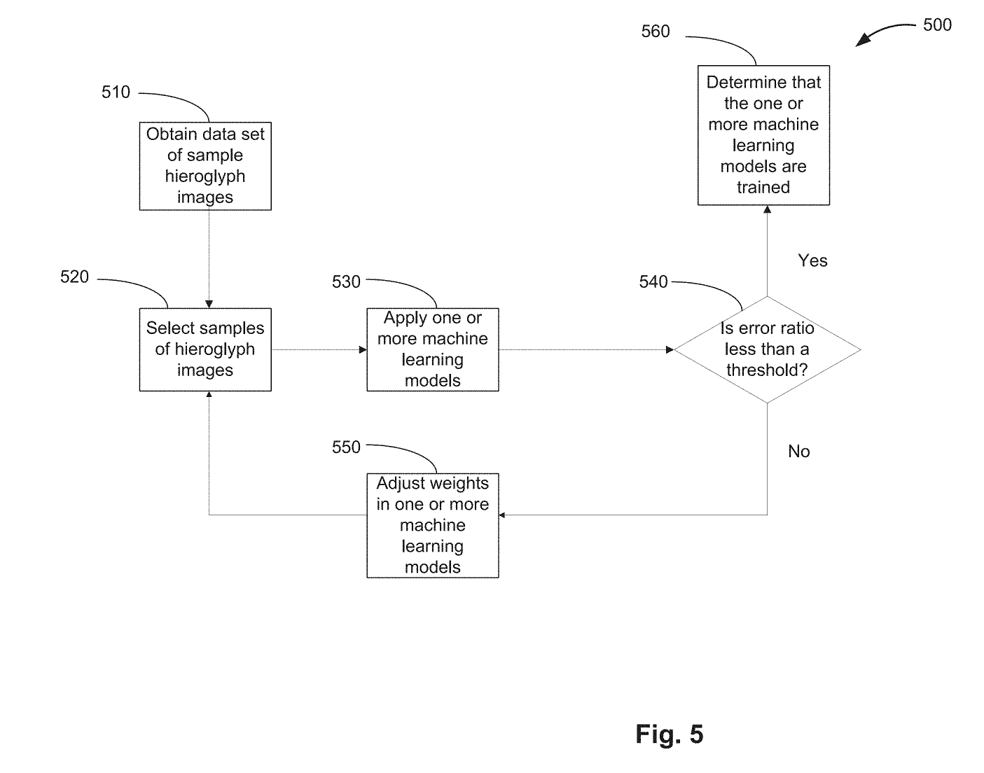

Server machine 150 may be a rackmount server, a router computer, a personal computer, a portable digital assistant, a mobile phone, a laptop computer, a tablet computer, a camera, a video camera, a netbook, a desktop computer, a media center, or any combination of the above. The server machine 150 may include a training engine 151. The machine learning model 114 may refer to a model artifact that is created by the training engine 151 using the training data that includes training inputs and corresponding target outputs (correct answers for respective training inputs). The training engine 151 may find patterns in the training data that map the training input to the target output (the answer to be predicted), and provide the machine learning model 114 that captures these patterns. The machine learning model 114 may be composed of, e.g., a single level of linear or non-linear operations (e.g., a support vector machine [SVM]) or may be a deep network, i.e., a machine learning model that is composed of multiple levels of non-linear operations. An example of a deep network is a convolutional neural network with one or more hidden layers, and such machine learning model may be trained by, for example, adjusting weights of a convolutional neural network in accordance with a backpropagation learning algorithm (described with reference to the method of FIG. 5) or the like.

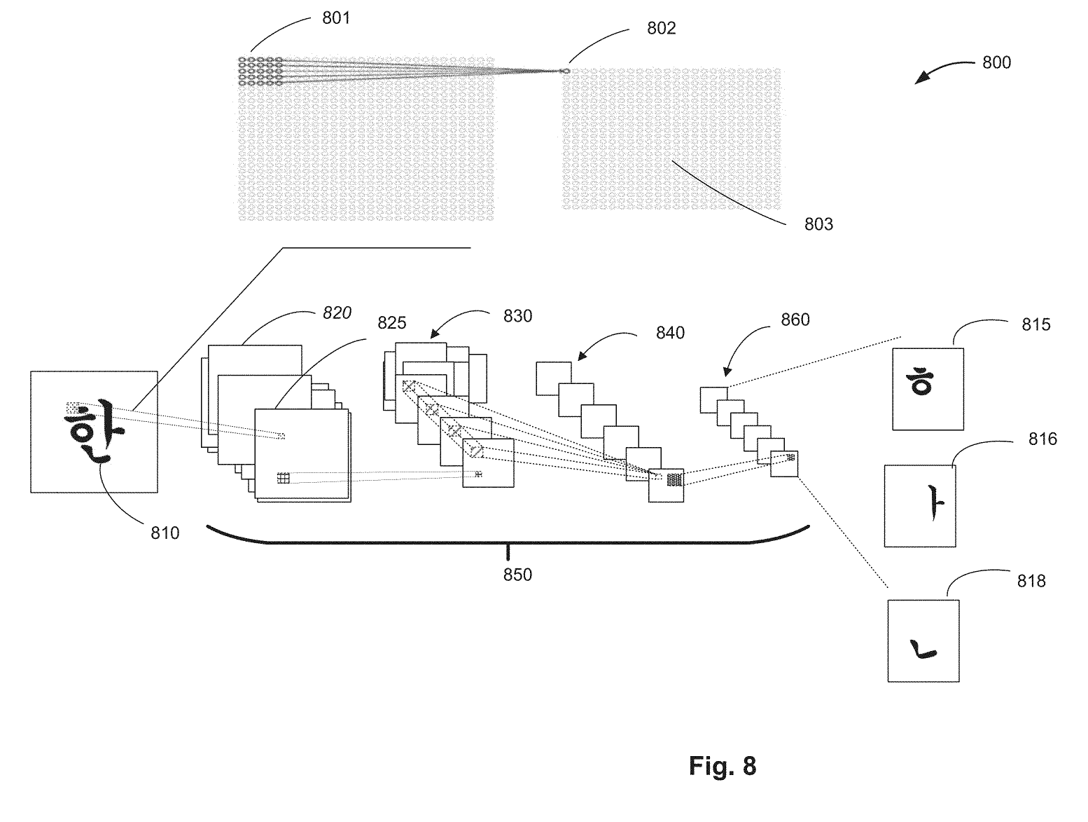

Convolutional neural networks include architectures that may provide efficient image recognition. Convolutional neural networks may include several convolutional layers and subsampling layers that apply filters to portions of the image of the hieroglyph to detect certain characteristics. That is, a convolutional neural network includes a convolution operation, which multiplies each image fragment by filters (e.g., matrices) element-by-element and sums the results in a similar position in an output image (example shown in FIG. 8).

In an implementation, one machine learning model may be used with an output that indicates the presence of a graphical element for each respective position in the hieroglyph. It should be noted that a graphical element may include an empty space, and the output may provide a likelihood for the presence of the empty space graphical element. For example, if there are three positions in a hieroglyph, the machine learning model may output three probability vectors. A probability vector may refer to a set of each possible graphical element variant, including the absence of a graphical element variant, that may be encountered at the respective position and a probability index associated with each variant that indicates the likelihood that the variant is present at that position. In another implementation, a separate machine learning model may be used for each respective position in the hieroglyph. For example, if there are three positions in a hieroglyph, three separate machine learning models may be used for each position. Additionally, a separate machine learning model 114 may be used for each separate language (e.g., Chinese, Japanese, and Korean).

As noted above, the one or more machine learning models may be trained to determine the combination of components at the positions in the hieroglyph. In one implementation, the one or more machine learning models 114 are trained to solve classification problems and to have an output for each class. A class in the present disclosure refers to a presence of a graphical element (e.g., including an empty space) in a position. A probability vector may be output for each position that includes each class variant and a degree of relationship (e.g., index probability) to the particular class. Any suitable training technique may be used to train the machine learning model 114, such as backpropagation.

Once the one or more machine learning models 114 are trained, the one or more machine learning models 114 can be provided to character recognition engine 112 for analysis of new images of hieroglyphs. For example, the character recognition engine 112 may input the image of the hieroglyph 141 obtained from the document 140 being analyzed into the one or more machine learning models 114. Based on the outputs of the one or more machine learning models 114 that indicate a presence of graphical elements in the positions in the hieroglyph being analyzed, the character recognition engine 112 may classify the hieroglyph as a particular language character. In an implementation, the character recognition engine 112 may identify the Unicode code in a Unicode character table that is associated with the recognized graphical element in each respective position and use the codes of the graphical elements to calculate the Unicode code for the hieroglyph. However, the character recognition engine 112 may determine, based on the probability vectors for the components output by the machine learning models 114, that for one of the predetermined positions or for several positions there is more than one graphical element identified that allows for an acceptable combination for more than one hieroglyph. In such an instance, the processing device 112 may perform additional classification, as described in more detail below, to classify the hieroglyph depicted in the image 141 being analyzed.

The repository 120 is a persistent storage that is capable of storing documents 140 and/or hieroglyph images 141 as well as data structures to tag, organize, and index the hieroglyph images 141. Repository 120 may be hosted by one or more storage devices, such as main memory, magnetic or optical storage based disks, tapes or hard drives, NAS, SAN, and so forth. Although depicted as separate from the computing device 110, in an implementation, the repository 120 may be part of the computing device 110. In some implementations, repository 120 may be a network-attached file server, while in other embodiments content repository 120 may be some other type of persistent storage such as an object-oriented database, a relational database, and so forth, that may be hosted by a server machine or one or more different machines coupled to the via the network 130.

FIG. 2A depicts an example of a graphical element 200, in accordance with one or more aspects of the present disclosure. In the depicted example, the graphical element 200 is a radical meaning “fence”. FIG. 2B depicts an example of a hieroglyph 202 including the graphical element 200 of FIG. 2A, in accordance with one or more aspects of the present disclosure.

As previously discussed, the Korean language is syllabic. Each hieroglyph represents a syllabic block of three graphical elements each located in a respective predetermined position. To illustrate, FIGS. 3A-3D depict three graphical elements arranged in the various predetermined positions of a Korean hieroglyph.

For example, FIG. 3A depicts an example of three graphical elements 300, 302, and 304 representing letters, in accordance with one or more aspects of the present disclosure. Each letter in the Korean language is a consonant, vowel, or diphthong. Korean graphical elements have a certain order in a syllable: 1) beginning consonant, 2) middle vowel or diphthong, and 3) final consonant. FIG. 3B depicts an example of predetermined positions in a hieroglyph where graphical elements may be located, in accordance with one or more aspects of the present disclosure. That is, each graphical element in a hieroglyph has a certain position (e.g., the location within the hieroglyph relative to the center and the rest of the graphical elements). The beginning consonant is located in a first position 310, the middle vowel or diphthong is located in a second position 312 or 314, which is either on the right of consonants at position 312 or between the consonants at position 314, and the final consonant is located in a third position 316. In some instances, the consonants may be doubled and there may be four or five letter syllables in the Korean language. In such instances, the one or more machine learning models 114 may be trained to recognize the double consonants as separate graphical elements. As such, the architecture of the one or more machine learning models 114 may be maintained as including outputs for the three positions (310, 312 or 314, and 316) in the hieroglyph.

FIG. 3C depicts an example hieroglyph 320 including the graphical elements 300, 302, and 304 of FIG. 3A arranged in certain positions of a first configuration, in accordance with one or more aspects of the present disclosure. In particular, the graphical element 300 is a consonant and is located in the first position 310, the graphical element 312 is a vowel and is located in the second position 312 (e.g., to the right of the consonants 300 and 304), and the graphical element 304 is a consonant and is located in the third position 316. FIG. 3D depicts another example hieroglyph 322 including graphical elements 324, 326, and 328 arranged in certain positions of a second configuration, in accordance with one or more aspects of the present disclosure. In particular, the graphical element 324 is a consonant and is located in the first position 310, the graphical element 326 is a vowel and is located in the second position 314 (e.g., in between the consonants 324 and 328), and the graphical element 328 is a consonant and is located in the third position 316.

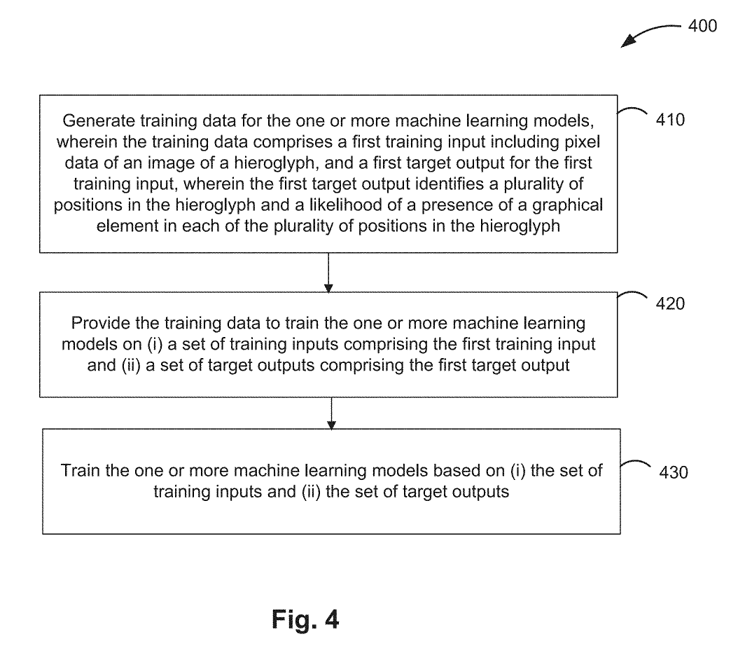

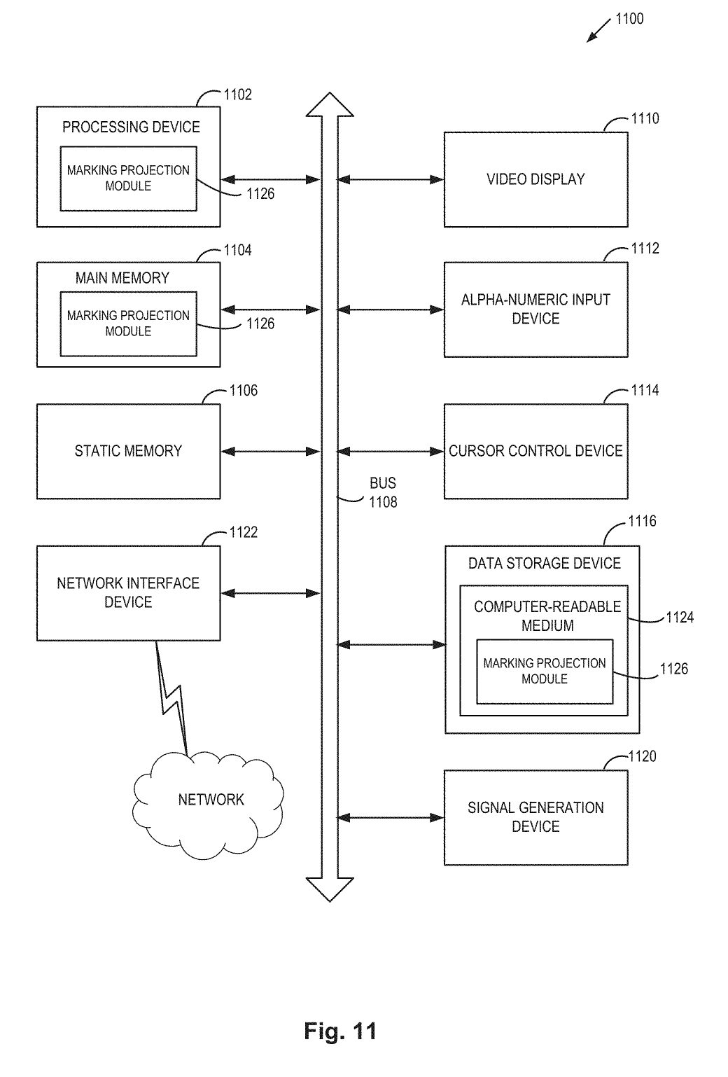

FIG. 4 depicts a flow diagram of an example method 400 for training one or more machine learning models 114, in accordance with one or more aspects of the present disclosure. The method 400 is performed by processing logic that may include hardware (circuitry, dedicated logic, etc.), software (such as is run on a general purpose computer system or a dedicated machine), or a combination of both. The method 400 and/or each of their individual functions, routines, subroutines, or operations may be performed by one or more processors of a computing device (e.g., computing system 1100 of FIG. 11) implementing the methods. In certain implementations, the method 400 may be performed by a single processing thread. Alternatively, the method 400 may be performed by two or more processing threads, each thread implementing one or more individual functions, routines, subroutines, or operations of the methods. The method 400 may be performed by the training engine 151 of FIG. 1.

For simplicity of explanation, the method 400 is depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events.

Method 400 may begin at block 410. At block 410, a processing device executing the training engine 151 may generate training data for the one or more machine learning models 114. The training data may include a first training input including pixel data of an image of a hieroglyph. In an implementation, the image of the hieroglyph may be tagged with a Unicode code associated with the particular hieroglyph depicted in the image. The Unicode code may be obtained from a Unicode character table. Unicode provides a system for representing symbols in the form of a sequence of codes built according to certain rules. Each graphical element in a hieroglyph and the hieroglyphs themselves have a code (e.g., number) in the Unicode character table.

The training data also includes a first target output for the first training input. The first target output identifies positions in the hieroglyph and a likelihood of a presence of a graphical element in each of the positions in the hieroglyph. The target output for each position may include a probability vector that includes a probability index (e.g., likelihood) associated with each component possible at each respective position. In one implementation, the probability indices may be assigned using the Unicode character table. For example, the training engine 151 may use the Unicode code tagged to the hieroglyph to determine the graphical elements in each of the positions of the hieroglyph. The following relationships may be used to calculate the graphical elements at each position based on the Unicode code of the hieroglyph (“Hieroglyph code”):

Final consonant at position 3=mod(Hieroglyph code−44032,28) (Equation 1)

Middle vowel or diphthong at position 2=mod(Hieroglyph code−44032−Beginning consonant at position 1,588)/28 (Equation 2)

Beginning consonant at position 1=1+int[(Hieroglyph code−44032)/588] (Equation 3)

The particular components identified at each position based on the Unicode code determined may be provided a high probability index, such as 1, in the probability vectors. The other possible components at each position may be provided a low probability index, such as 0, in the probability vectors. In some implementations, the probability indices may be manually assigned to the graphical elements at each position.

At block 420, the processing device may provide the training data to train the one or more machine learning models on (i) a set of training inputs including the first training input and (ii) a set of target outputs including the first target output.

At block 430, the processing device may train the one or more machine learning models based on (i) the set of training inputs and (ii) the set of target outputs. In one implementation, the machine learning model 114 may be trained to output the probability vectors for the presence of each possible component at each position in the hieroglyph. In instances where a single machine learning model 114 is used for the Korean language, for example, three arrays of probability vectors may be output, one for each position in the hieroglyph. In another implementation, where a separate machine learning model 114 is used for each position, each machine learning model may output a single array of probability vectors indicating likelihoods of components present at its respective position. Upon training completion, the one or more machine learning models 114 may be trained to receive pixel data of an image of a hieroglyph and determine a combination of components at positions in the hieroglyph.

FIG. 5 depicts a flow diagram of an example method 500 for training one or more machine learning models 114 using backpropagation, in accordance with one or more aspects of the present disclosure. Method 500 includes operations performed by the computing device 110. The method 500 may be performed in the same or a similar manner as described above in regards to method 400. Method 500 may be performed by processing devices of the computing device 110 and executing the training engine 151.

Method 500 may begin at block 510. At block 510, a processing device executing the training engine 151 may obtain a data set of sample hieroglyph images 141 including their graphical elements. Images of hieroglyphs including their graphical elements may be used for training. The data set of sample hieroglyph images may be separated into one or more subsamples used for training and testing (e.g., in a ratio of 80 percent to 20 percent, respectively). The training subsample may be tagged with information (e.g., a Unicode code) regarding the hieroglyph depicted in the image, the graphical element located in each position in the hieroglyph, or the like. The testing subsample may not be tagged with information. Each of the images in the training subsample may be preprocessed as described in detail below with reference to the method of FIG. 6.

At block 520, the processing device may select image samples from the training subsample to train the one or more machine learning models. Training image samples may be selected sequentially or in any other suitable way (e.g., randomly). At block 530, the processing device may apply the one or more machine learning models to the selected training subsample and determine an error ratio of the machine learning model outputs. The error ratio may be calculated in accordance with the following relationship:

$$\sqrt{{\sum }_{i} {( {x}_{i} - {x}_{i}^{o} )}^{2}} \qquad ( Equation 4 )$$

Where xᵢ are the values of the probability vector and xᵢ^{o} is the expected value of the probability vector at the output from the machine learning model. In some implementations, this parameter may be set manually during training of the machine learning model 114. Σ is the sum of the components of the probability vector at the output from machine learning model.

A determination is made at block 540 whether the error ratio is less than a threshold. If the error ratio is equal to or greater than the threshold then the one or more machine learning models may be determined to not be trained and one or more weights of the machine learning models may be adjusted (block 550). Weight adjustment may be performed using any suitable optimization technique, such as differential evolution. The processing device may return to block 520 to select sample images and continue processing to block 530. This iterative process may continue until the error ratio is less than the threshold.

If the error ratio is below the threshold, then the one or more machine learning models 114 may be determined to be trained (block 560). In one implementation, once the one or more machine learning models 114 are determined to be trained, the processing device may select test image samples from the testing subsample (e.g., untagged images) (block 520). Testing may be performed on the selected testing image samples that have not yet been processed by the one or more machine learning models. The one or more machine learning models may be applied (block 530) to the test image samples. At block 540, the processing device may determine whether an error ratio for the outputs of the machine learning models 114 applied to the test image samples is less than the threshold. If the error ratio is higher or equal to the threshold, the processing device may return to block 520 to perform additional training. If the error ratio is less than the threshold, the processing device may determine (block 560) that the one or more machine learning models 114 are trained.

FIG. 6 depicts a flow diagram of an example method 600 for preprocessing a document 140 to identify images 141 of hieroglyphs, in accordance with one or more aspects of the present disclosure. Method 600 includes operations performed by the computing device 110. Method 600 may be performed in the same or a similar manner as described above in regards to methods 400 and 500. Method 600 may be performed by processing devices of the computing device 110 executing the character recognition engine 112.

Method 600 may begin at block 610. At block 610, a document 140 may be digitized (e.g., by photographing or scanning) by the processing device. The processing device may preprocess (block 620) the digitized document. Preprocessing may include performing a set of operations to prepare the image 140 for further character recognition processing. The set of operations may include eliminating noise, modifying the orientation of hieroglyphs in the image 140, straightening of lines of text, scaling, cropping, enhancing contrast, modifying brightness, and/or zooming. The processing device may identify (block 630) hieroglyph images 141 included in the preprocessed digitized document 140 using any suitable method. The identified hieroglyph images 141 may be divided into separate images for individual processing. Further, at block 640, the hieroglyphs in the individual images may be calibrated by size and centered. That is, in some instances, each hieroglyph image may be resized to a uniform size (e.g., 30×30 pixels) and aligned (e.g., to the middle of the image). The preprocessed and calibrated images of the hieroglyphs may be provided as input to the one or more trained machine learning models 114 to determine a combination of components at positions in the hieroglyphs.

FIG. 7 depicts a flow diagram of an example method 700 for classifying a hieroglyph as a particular language character based on a determined combination of components at positions in the hieroglyph, in accordance with one or more aspects of the present disclosure. Method 700 includes operations performed by the computing device 110. Method 700 may be performed in the same or a similar manner as described above in regards to method 400, 500, and 600. Method 700 may be performed by processing devices of the computing device 110 executing the character recognition engine 112.

Method 700 may begin at block 710. At block 710, the processing device may identify an image 141 of a hieroglyph in a digitized document 140. The processing device may provide (block 720) the image 141 of the hieroglyph as input to a trained machine learning model 114 to determine a combination of components at positions in the hieroglyph. As previously discussed, the hieroglyph may be a character in the Korean language and include graphical elements at three predetermined positions. However, it should be noted that the character may be from the Chinese or Japanese languages. Further, in some implementations, the machine learning model may output three probability vectors, one for each position, of likelihoods of components at each position. In another implementation, the machine learning model may include numerous machine learning models, one for each position in the hieroglyph. Each separate machine learning model may be trained to output a likelihood of components at its respective position.

At block 730, the processing device may classify the hieroglyph as a particular language character based on the determined combination of components at the positions in the hieroglyph. In one implementation, if a component at each position has a likelihood above a threshold (e.g., 75 percent, 85 percent, 90 percent), then the character recognition engine 112 may classify the hieroglyph as the particular language character that includes the components at each position. In one implementation, the processing device may identify a Unicode code associated with the recognized components at each position using a Unicode character table. The processing device may derive the Unicode code for the hieroglyph using the following relationship:

0xAC00+(Beginning consonant Unicode code−1)×588+(Middle vowel diphthong Unicode code−1)×28+(Final consonant Unicode code or 0) (Equation 5)

After deriving the Unicode code for the hieroglyph, the processing device may classify the hieroglyph as the particular language character associated with the hieroglyph's Unicode code for the image 141 being analyzed. In some implementations, the results (e.g., the image 141, the graphical elements at each position, the classified hieroglyph, and particular language character) may be stored in the repository 120.

In some instances, the probability vector output for a single position or for multiple positions may indicate that more than one component may allow for an acceptable combination for more than one hieroglyph, additional classification may be performed. In one implementation, the processing device may analytically form acceptable hieroglyphs and derive the most probable hieroglyph based on the acceptable hieroglyphs. In other words, the processing device may generate every combination of the components at each position to form the acceptable hieroglyphs. For example, if graphical element x was determined for the first position in the hieroglyph, graphical element y was determined for the second position, and graphical elements z1 or z2 were determined for the third position, two acceptable hieroglyphs may be formed having either configuration x, y, z1, or x, y, z2. The most probable hieroglyph may be determined by deriving products of the values of the components of the probability vectors output by the machine learning model and comparing them with each other. For example, the processing device may multiply the values (e.g., probability index) of the probability vectors for x, y, z1 and multiply the values of probability vectors for x, y, z2. The product of the values for x, y, z1 and x, y, z2 may be compared and the product that is greater may be considered the most probable combination of components. As a result, the processing device may classify the hieroglyph as a particular language character based on the determined combination of components at positions in the hieroglyph that results in the greater product.

In another example, when more than one component is possible for one or more of the positions in view of the probability vectors output by the machine learning model 114, the output information (e.g., probability vectors for each position) may be represented as a multidimensional space of parameters and a model may be applied to the space of parameters. In an implementation, a mixture of Gaussian distributions is a probabilistic model, which may assume that every sampling point is generated from a mixture of a finite number of Gaussian distributions with unknown parameters. The probabilistic model may be considered a generalization of k-means clustering technique, which includes, in addition to information about the center of the cluster, information about Gaussian covariance. Expectation-maximization (EM) technique may be used for classification and to select parameters of the Gaussian distributions in the model.

The EM technique enables building models for a small number of representatives of a class. Each model has one class. A trained model determines the probability with which a new class representative can be assigned to a class of this model. The probability is expressed in numerical index from 0 to 1, and the closer the indicator to unity, the greater the probability that the new representative of the class belongs to the class of this model. The class may be a hieroglyph and the representative of the class is an image of the hieroglyph.

In an implementation, the input to the probabilistic model is the results (e.g., three probability vectors of components at positions in the hieroglyph) from the machine learning model 114. The processing device may build a multi-dimensional space, where the digitized 30×30 image of the hieroglyph is represented. The dimensionality of the space is 71 (e.g., the number of components of the probability vectors for the positions output from the machine learning model 114). A Gaussian model may be constructed in the multi-dimensional space. A distribution model may correspond to each hieroglyph. The Gaussian model may represent the probability vectors of components at positions determined by the machine learning model as a multi-dimensional vector of features. The Gaussian model may return a weight of a distribution model that corresponds to a particular hieroglyph. In this way, the processing device may classify the hieroglyph as a particular language character based on the weight of a corresponding distribution model.

The probabilistic model may be generated in accordance with one or more of the following relationships:

$${\sum }_{i}^{n} {L}_{j} {e}^{- {\sum }_{i}^{71} {( \frac{{x}_{i} - {x}_{ji}^{0}}{{G}_{ji}} )}^{L}} \qquad ( Equation 6 )$$

Where i is the number of a characteristic of the component, is a point in the multi-dimensional space, xⱼᵢ⁰ and Lⱼ are model variables, and L is a coefficient. A contribution of each component at each position may be derived in accordance with the following relationship:

$${n}_{components} = min ( [ \frac{{n}_{elements}}{5} ] , 5 ) \qquad ( Equation 7 )$$

Where n_{components} is the number of components on which the probabilistic model is built, nₑₗₑₘₑₙₜₛ is the number of elements of a training sample,

$$[ \frac{{n}_{elements}}{5} ]$$

is the minimal integer of representatives of the class divided by 5, where 5 is a number determined experimentally and added for better convergence of the technique in conditions of a limited training sample.

$$min ( [ \frac{{n}_{elements}}{5} ] , 5 )$$

is the minimum value from

$$[ \frac{{n}_{elements}}{5} ]$$

and 5, where 5 is also the number determined experimentally and added for better convergence of the techniques in conditions of limited training sample.

FIG. 8 depicts a block diagram of an example of a neural network 800 trained to recognize the presence components at positions in a hieroglyph 810, in accordance with one or more aspects of the present disclosure. In an implementation, the neural network outputs a likelihood of a component being present for each of the permissible positions in a hieroglyph. As described above, the neural network 800 may include outputs for each position or there may be separate neural networks 800 for each position. The neural network 800 may include a number of convolutional and subsampling layers 850, as described below.

As noted earlier, the structure of a neural network can be any suitable type. For example, in one of implementations, the structure of a convolutional neural network used by the character recognition engine 112 is similar to LeNet (convolutional neural network for recognition of handwritten digits). The convolutional neural network may multiply each image fragment by the filters (e.g., matrices) element-by-element and the result is summed and recorded in a similar position of the output image.

A first layer 820 in the neural network is convolutional. In this layer 820, the value of the original preprocessed image (binarized, centered, etc.) is multiplied by the values of filters 801. The filter 801 is a pixel matrix having certain dimensions. In this layer the filter sizes are 5×5. Each filter detects a certain characteristic of the image. The filters pass through the entire image starting from the upper left corner. The filters multiply the values of each filter by the original pixel values of the image (element multiplication). The multiplication are summed to produce a single number 802. Filters move through the image to the next position in accordance with the specified step and the convolution process is repeated for the next fragment of the image. Each unique position of the input image produces a number (e.g., 802). After passing the filter across all positions, a matrix is obtained, which is called a feature map 803. The first convolution was carried out by 20 filters, as a result of which we obtained 20 feature map 825 having size 24×24 pixels.

The next layer 830 in the neural network 800 includes down-sampling. The layer 830 performs an operation of decreasing the discretization of spatial dimensions (width and height). As a result, the size of feature maps decrease (e.g., 2 times because filters may have a size of 2×2). At this layer 830, non-linear compaction of the feature map is performed. For example, if some features of the graphical elements have already been revealed in the previous convolution operation, then a detailed image is no longer needed for further processing, and it may be compressed to less detailed pictures. In the case of a subsampling layer, the features may be generally easier to compute. That is, when a filter is applied to an image, multiplication may not be performed, but a simpler mathematical operation, for example, searching for the largest number in the image fragment may be performed. The largest number may be entered in the feature map, and the filter moves to the next fragment. Such an operation may be repeated until full coverage of the image is obtained.

In another convolutional layer 840, the convolution operation is repeated with the help of a certain number of filters having a certain size (e.g., 5×5). In one implementation, in layer 840, the number of filters used is 50, and thus, 50 features are extracted and 50 feature maps are created. The resulting feature maps may have a size of 8×8. At another subsampling layer 860, 50 feature maps may be compressed (e.g., by applying 2×2 filters). As a result, 25050 features may be collected.

These features may be used to classify whether certain graphical elements 816, and 818 are present at the positions in the hieroglyph. If the features detected by the convolutional and subsampling layers 850 indicate that a particular component is present at a position in the hieroglyph, a high probability index may be output for that component in the probability vector for that position. In some instances, based on the quality of the image, hieroglyph, graphical element in the hieroglyph, other factors, the neural network 800 may identify more than one possible graphical element for one or more of the positions in the hieroglyph. In such cases, the neural network may output similar probability indices for more than one component in the probability vector for the position and further classification may be performed, as described above. Once the components are classified for each position the hieroglyph, the processing device may determine the hieroglyph that is associated with the components (e.g., by calculating the Unicode code of the hieroglyph).

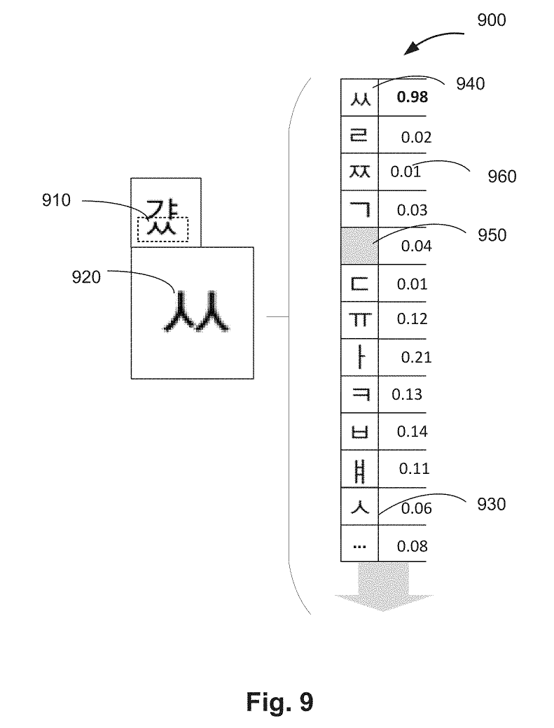

FIG. 9 depicts an example array 900 of probability vector components and associated indices output by a machine learning model 114, in accordance with one or more aspects of the present disclosure. The array 900 includes a set of every possible graphical element variant that can be encountered in a particular position (e.g., first position, second position, third position in the Korean language), and the absence of a graphical element (e.g., 950) in the particular position is also one of the possible variants. The depicted array 900 includes the probability vector components 930 and indices for the third position of a Korean hieroglyph 910 (not every components are depicted). As shown, component 920 includes a double component and the machine learning model 114 output a high probability (0.98) index for the double component in the array 900. As such, the machine learning model 114 may output the vector component 930 for every admissible component at a given position as well as the vector components for dual graphemes 940. The probability index values may range from 0 to 1, where the closer the numerical index to 1, the greater the probability of finding one or two graphical elements in the position. As depicted, the machine learning model 114 output a low probability index 760 for another component that is determined to not be likely in the position.

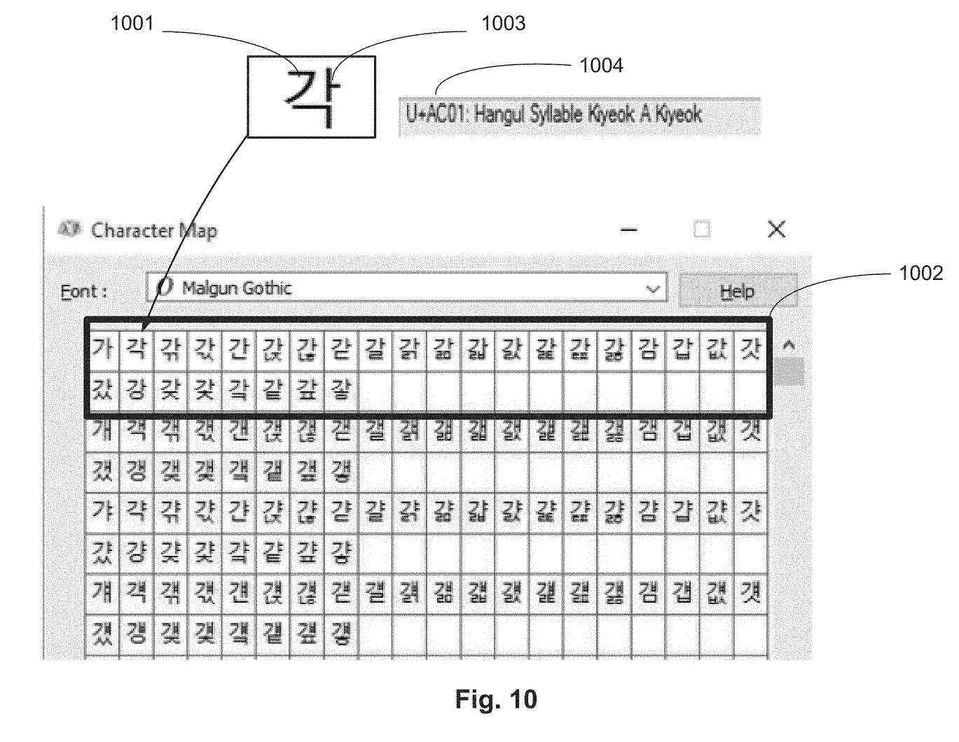

FIG. 10 depicts an example Unicode table for the Korean language, in accordance with one or more aspects of the present disclosure. Unicode provides a system for representing symbols in the form of a sequence of codes built according to certain rules. As discussed above, Korean hieroglyphs include letters that have a certain sequence: the beginning consonant, middle vowel or diphthong, and final consonant. The hieroglyphs of the Korean language in the Unicode system are encoded in groups. For example, the hieroglyphs are divided into 19 groups of 588 characters, where the hieroglyphs of each group begin with the same consonant 1001. Each of the 19 groups is further divided into 21 subgroups 1002 depending on the middle vowel or diphthong 1003. That is, in each subgroup 1002, there are just hieroglyphs having the same middle vowel or diphthong 1003. Each subgroup 1002 includes 28 characters. Every letter (e.g., graphical element) and every character (e.g., hieroglyph) has a code (e.g., number) in the Unicode system. For example, the hieroglyph depicted has code U+AC01 (1004). As described above, the processing device may use identified codes for the components in each position in a hieroglyph to derive the code for the particular hieroglyph and classify the particular hieroglyph as a language character.

FIG. 11 depicts an example computer system 1100 which can perform any one or more of the methods described herein, in accordance with one or more aspects of the present disclosure. In one example, computer system 1100 may correspond to a computing device capable of executing character recognition engine 112 of FIG. 1. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 1100 includes a processing device 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)), and a data storage device 1116, which communicate with each other via a bus 1108.

Processing device 1102 represents one or more general-purpose processing devices such as a microprocessor, central processing unit, or the like. More particularly, the processing device 1102 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also be one or more special-purpose processing devices such as an application specific integrated circuit (ASIC), a field programmable gate array (FPGA), a digital signal processor (DSP), network processor, or the like. The processing device 1102 is configured to execute the character recognition engine 112 for performing the operations and steps discussed herein.

The computer system 1100 may further include a network interface device 1122. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), and a signal generation device 1120 (e.g., a speaker). In one illustrative example, the video display unit 1110, the alphanumeric input device 1112, and the cursor control device 1114 may be combined into a single component or device (e.g., an LCD touch screen).

The data storage device 1116 may include a computer-readable medium 1124 on which is the character recognition engine 112 (e.g., corresponding to the methods of FIGS. 4-7, etc.) embodying any one or more of the methodologies or functions described herein is stored. Character recognition engine 112 may also reside, completely or at least partially, within the main memory 1104 and/or within the processing device 1102 during execution thereof by the computer system 1100, the main memory 1104 and the processing device 1102 also constituting computer-readable media. Character recognition engine 112 may further be transmitted or received over a network via the network interface device 1122.

While the computer-readable storage medium 1124 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “setting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
identifying, by a processing device, an image of a hieroglyph;
providing the image of the hieroglyph as input to a trained machine learning model to determine a combination of components at a plurality of positions in the hieroglyph; and
classifying the hieroglyph as a particular language character based on the determined combination of components at the plurality of positions in the image.

2. The method of claim 1, wherein the machine learning model comprises a plurality of machine learning models, the plurality of machine learning models including a respective machine learning model for each position of the plurality of positions to determine presence of a component at each position.

3. The method of claim 1, comprising, prior to providing the image of the hieroglyph as input to the machine learning model, training the machine learning model to determine the combination of components at the plurality of positions in the hieroglyph, wherein training the machine learning model comprises:
providing input of a first portion of sample hieroglyph images to the machine learning model; and
deriving a first error ratio in view of outputs of the machine learning model for the first portion of the sample hieroglyph images.

4. The method of claim 3, wherein training the machine learning model further comprises:
in response to a determination that the first error ratio is less than a threshold, determining that the machine learning model is trained; or
in response to a determination that the first error ratio is equal to or greater than the threshold:
determining that the machine learning model is not trained; and
adjusting weights of the machine learning model.

5. The method of claim 4, wherein training the machine learning model further comprises:
in response to a determination that the machine learning model is trained, providing input of a second portion of the sample hieroglyph images to the machine learning model, wherein the second portion of the sample hieroglyph images are untagged and have not been processed by the machine learning model;
deriving a second error ratio in view of outputs of the machine learning model for the second portion of the sample hieroglyph images; and
in response to a determination that the second error ratio is less than the threshold, determining that the machine learning model is trained, or in response to a determination that the first error ratio is equal to or greater than the threshold:
determining that the machine learning model is not trained; and
adjusting weights of the machine learning model.

6. The method of claim 3, wherein training the machine learning model further comprises associating a Unicode code with the hieroglyph.

7. The method of claim 1, wherein classifying the hieroglyph as the particular language character based on the determined combination of components at the plurality of positions in the hieroglyph further comprises:
responsive to a determination that the combination of components at the plurality of positions correspond to a plurality of hieroglyphs, generating every combination of the components at each of the plurality of positions for the plurality of hieroglyphs;
deriving, for each combination, a product of probability values of the components in probability vectors associated with each of the components at each of the plurality of positions; and
responsive to a determination that a particular hieroglyph of the plurality of hieroglyphs includes a largest product of probability values of the components of the probability vectors associated with each of the components at each of the plurality of positions, classifying the particular hieroglyph as the particular language character.

8. The method of claim 1, wherein classifying the hieroglyph as the particular language character based on the determined combination of components at the plurality of positions in the hieroglyph further comprises:
responsive to a determination that the combination of the components at each of the plurality of positions corresponds to a plurality of hieroglyphs, generating every combination of the components at each of the plurality of positions for the plurality of hieroglyphs;
determining a probability for each combination indicative of whether each combination represents a particular hieroglyph, wherein the determination is made using a Gaussian model constructed in a multi-dimensional space that includes a feature of the image of the hieroglyph for each pixel; and
classifying the combination representing the particular hieroglyph with the highest probability as the particular language character.

9. The method of claim 1, wherein the machine learning model comprises a convolutional neural network that multiplies pixel values at each portion of the image by a filter and sums results in a corresponding position in an output image of the hieroglyph, wherein each filter detects a characteristic of the hieroglyph.

10. The method of claim 1, wherein the particular language character is from a language comprising Chinese, Japanese, or Korean.

11. The method of claim 1, wherein the components comprise a graphical element or an empty space and the components represent a consonant, vowel, or diphthong depending on which position of the plurality of positions that the components are located.

12. A method for training one or more machine learning models to identify a presence or absence of graphical elements at a plurality of positions in a hieroglyph, the method comprising:
generating training data for the one or more machine learning models, wherein the training data comprises a first training input including pixel data of an image of a hieroglyph, and a first target output for the first training input, wherein the first target output identifies the plurality of positions in the hieroglyph and a likelihood of a presence of a graphical element in each of the plurality of positions in the hieroglyph; and
providing the training data to train the one or more machine learning models on (i) a set of training inputs comprising the first training input and (ii) a set of target outputs comprising the first target output.

13. The method of claim 12, wherein the hieroglyph comprises a Chinese, Japanese, or Korean language character.

14. The method of claim 12, wherein the one or more machine learning models is configured to:
process a new image including a hieroglyph;
generate one or more outputs indicating a likelihood that the hieroglyph includes a presence or absence of one or more graphical elements in one or more positions; and
classify the hieroglyph as a particular language character based on the outputs.

15. The method of claim 12, wherein the one or more machine learning models comprise convolutional neural networks that multiply pixel values at each portion of the image by a filter and sums results in a corresponding position in an output image of the hieroglyph, wherein each filter detects a characteristic of the hieroglyph.

16. An apparatus comprising:
a memory; and
a processing device, operatively coupled to the memory, to:
identify, by a processing device, an image of a hieroglyph;
provide the image of the hieroglyph as input to a trained machine learning model to determine a combination of components at a plurality of positions in the hieroglyph; and
classify the hieroglyph as a particular language character based on the determined combination of components at the plurality of positions in the hieroglyph.

17. The apparatus of claim 16, wherein the machine learning model comprises a plurality of machine learning models, the plurality of machine learning models including a respective machine learning model for each position of the plurality of positions to determine the combination of components at each position.

18. The apparatus of claim 16, wherein the processing device is further to, prior to providing the image of the hieroglyph as input to the machine learning model, train the machine learning model to determine the combination of components at the plurality of positions in the hieroglyph, wherein training the machine learning model comprises the processing device to:
provide input of a first portion of sample hieroglyph images to the machine learning model; and
derive a first error ratio in view of outputs of the machine learning model for the first portion of the sample hieroglyph images.

19. The apparatus of claim 18, wherein training the machine learning model comprises the processing device further to associate a Unicode code with the hieroglyph.

20. The apparatus of claim 16, wherein the machine learning model comprises a convolutional neural network that multiplies pixel values at each portion of the image of the hieroglyph by a filter and sums results in a corresponding position in an output image of the hieroglyph, wherein each filter detects a characteristic of the hieroglyph in the image.
